(19) United States
(12) Patent Application Publication
(10) Pub. No.: US 2008/0285266 A1
(43) Pub. Date: Nov. 20, 2008

(54) THERMAL MANAGEMENT FOR FLUORESCENT BALLAST AND FIXTURE SYSTEM

(76) Inventor: Edward John Thomas, Streetsboro, OH (US)

Correspondence Address: FAY SHARPE LLP, 1100 SUPERIOR AVENUE, SEVENTH FLOOR, CLEVELAND, OH, 44114, US

(21) Appl. No.: 11/748,028

(22) Filed: May 14, 2007

(51) Int. Cl. F21V 29/00; H01J 9/00

(52) U.S. Cl. 362/218; 445/26

(57) ABSTRACT

A fluorescent lamp assembly includes a fixture which supports at least one fluorescent lamp. A ballast is mounted to the fixture for controlling a supply of electrical current to the fluorescent lamp. A thermal transfer material is interposed between the ballast and a portion of the fixture whereby heat is transferred between the ballast and the fixture.

### BACKGROUND OF THE INVENTION

The exemplary embodiment relates to the illumination arts. It finds particular application in connection with thermal management in a ballast for a lighting fixture and will be described with particular reference thereto.

Lighting fixtures, such as those which support fluorescent lamps, typically employ a ballast to control the current supplied to the lamps. Typically, the ballast used for a fluorescent lighting fixture is an electronic ballast. The ballast includes a circuit board which carries components such as filters, rectifiers, and capacitors, for rectifying the AC current input and providing a high voltage during initial start-up of the lamp. These components can be damaged if subjected to high temperatures. Under most operating conditions, however, any heat generated by the ballast is dissipated to the atmosphere via the ballast housing or through the relatively cool fixture and the ballast does not suffer overheating problems.

Fluorescent lamps are now being used in a variety of applications, such as industrial applications and in facilities with high ceilings where the ambient temperatures are relatively high. It is not uncommon for ambient temperatures to reach 50-60° C., or more, in some environments. Such temperatures can compromise the operation of the ballast and result in shorter operational lifetimes. Where the fixture is positioned in a relatively inaccessible location, it is inconvenient to access the fixture for ballast replacement.

### BRIEF DESCRIPTION OF THE INVENTION

In accordance with one aspect of the exemplary embodiment, a fluorescent lamp assembly includes a fixture which supports at least one fluorescent lamp. A ballast is mounted to the fixture for controlling a supply of electrical current to the fluorescent lamp. A thermal transfer material is interposed between the ballast and a portion of the fixture whereby heat is transferred between the ballast and the fixture.

In accordance with another aspect, a method of operating a fluorescent lamp assembly in an environment which reaches temperatures in excess of about 50° C. during operation of the lamp, is provided. The method includes supporting at least one fluorescent lamp on a fixture, mounting a ballast to the fixture, and interposing a thermal transfer material between the ballast and a portion of the fixture whereby heat is transferred between the ballast and the fixture during operation of the lamp.

In accordance with another aspect, a fluorescent lamp assembly includes a ballast and a fixture which supports a fluorescent lamp, the ballast being adhesively attached to the fixture with a thermal transfer material comprising a room temperature vulcanizing silicone and optionally a particulate material. The thermal transfer material aids in conducting heat from the ballast to the fixture during operation of the fluorescent lamp at an ambient temperature of at least 50° C.

### BRIEF DESCRIPTION OF THE DRAWINGS

FIG. 1 is a side sectional view of a lamp assembly in accordance with one aspect of the exemplary embodiment; and

FIG. 2 illustrates a lamp assembly in accordance with another aspect of the exemplary embodiment.

### DETAILED DESCRIPTION OF THE INVENTION

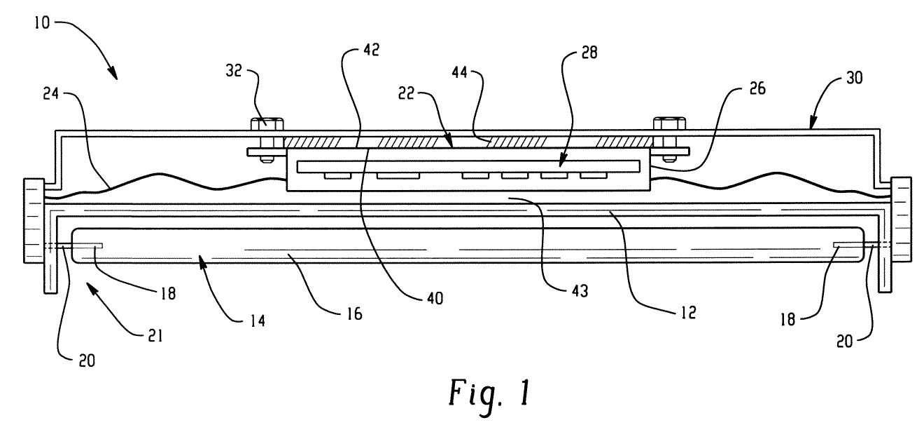

With reference to FIG. 1, an exemplary lighting assembly includes a fixture 10, such as a fluorescent fixture. The fixture includes a chassis 12 which supports one or more fluorescent lamps 14 which emit light when energized. Each of the lamps 14 may include a tube 16, which encloses a gaseous fill capable of sustaining a discharge between electrodes 18 at opposite ends of the tube. The fill may include a small quantity of mercury with an inert gas, such as argon. A phosphor material may be provided on an interior surface of the tube 16. When the mercury vapor is ionized inside the tube, the lamp discharge emits radiation, including ultraviolet, that in converted to visible light by the phosphor coating. Base pins 20 carry the current to and from the electrodes. The illustrated lamp 14 is a double ended lamp and is supported by the chassis at opposite ends of the lamp. Single ended “Biax” lamps may also be utilized.

The chassis 12 defines a cavity for receiving the fluorescent lamp. The chassis may be formed of a reflective material or interiorly coated with a reflective material to reflect light from the lamp 14 which is incident thereon.

A ballast 22, such as an electronic ballast, supplies the electrodes 18 with current. In the illustrated embodiment, electrical wiring 24 connects with the pins 20 through the chassis. The ballast includes a ballast housing 26, which houses electronic circuit board 28 which supports the electronic components of the ballast thereon. The ballast is mounted to a part of the fixture by fixing members, such as bolts 32, screws, or the like. In the illustrated embodiment, the ballast is mounted to a ballast box 30 at one or both ends of the ballast housing. In other embodiments, the center of the ballast hosing may be mounted to the ballast box. The ballast box 30 mounts the ballast to the rest of the fixture. In particular, the ballast box is removably mounted at either end to the chassis. The ballast box is formed from metal, such as a thin gauge sheet metal, such as steel or aluminum, and serves as a heat sink for the ballast. In particular the ballast box 30 may have a large surface area from which heat is transferred to the atmosphere by conduction and radiation. The ballast box may be coated with an emissive material, such as a black coating, which aids thermal transfer from the ballast to the surrounding atmosphere.

The ballast housing 26 includes a closure in the form of a planar member 40 which defines a planar exterior surface 42. The planar surface 42 contacts an adjacent planar surface of the ballast box 30 when affixed thereto. In the illustrated embodiment, the ballast box 30 supports the ballast 22 so that the ballast is spaced from the chassis by an air gap 43, and thereby to some degree is spaced from the heat generated by the fluorescent lamps. A major portion of the excess heat generated by the ballast 22 is transferred to the planar member 40 by virtue of the location of the circuit board. Under normal ambient conditions, a sufficient contact area exists between the planar surface 42 and the ballast box 30 to ensure that the excess heat is dissipated. However, in high-ceiling locations and facilities where high temperatures are experienced, the heat may not be dissipated rapidly enough to maintain the circuitry of the ballast at a suitable operating temperature. Accordingly, a thermal transfer material 44 is interposed between the ballast box 30 and the ballast housing 26. For example, the thermal transfer material 44 may be applied to the ballast box 30 or planar surface 42 prior to fixing the ballast to the ballast box with bolts, screws or other fixing members. The thermal transfer material 44 may be applied in the form of a gel, paste, pad, or the like. The material 44 reduces the air gaps between the ballast box 30 and the ballast housing 26, thereby increasing the area of thermal contact and decreasing the thermal resistance.

The thermal transfer material 44 may be an adhesive composition which retains its adhesive character, i.e., does not flow appreciably, at the operating temperature of the ballast 22 or temperature of surfaces of the fixture which the material 44 contacts. In one embodiment, the thermal transfer material 44 is applied as a flowable liquid or viscous material or paste and cures to a substantially non-flowable material, e.g., solid, gel, or highly viscous material, at room temperature. Exemplary curing agents include platinum catalysts and organic peroxide compounds. The thermal transfer material transfers heat more effectively between the ballast and the fixture as compared to when it is absent.

Exemplary thermal transfer materials include polymers, such as silicones and acrylic-based materials. Exemplary silicones are room temperature vulcanizing (RTV) silicones which cure to a relatively firm material in the atmosphere. Such materials are obtainable from General Electric Co., Silicone Products Division, e.g., RTV108 silicone. This material has adhesive properties which are retained under lamp operating conditions. Other suitable polymers include viscous waxes, asphaltic pitches, and the like.

U.S. Pat. No. 5,493,041, which is incorporated herein in its entirety by reference, discloses crosslinked organofunctional siloxane waxes and methods for their preparation, which may be utilized herein. For example, the crosslinked organofunctional silicone wax can be prepared by reacting a commercially available siloxane having silicon-bonded hydrogen atoms with a slight stoichiometric excess of an olefin and an unconjugated alpha, omega-diene crosslinker in the presence of a transition metal (e.g., platinum) catalyst. Olefins are known in the art and commercially available. Mixtures of olefins having different numbers of carbon atoms can be used, for example mixtures of olefins having 30 carbon atoms and olefins having greater than 30 carbon atoms can be used to prepare the crosslinked organofunctional silicone wax. The crosslinker can be an organic group, an organosilicone having an average of at least two alkenyl groups bonded to silicon atoms per molecule, a combination thereof, and others.

Other suitable curable silicone materials are described in U.S. Pat. No. 6,639,008 to Lewis, et al., the disclosure of which is incorporated herein by reference.

Optionally, a thermally conductive particulate filler material is dispersed in the polymer matrix. Exemplary particulate materials include aluminum oxide, silicon nitride, aluminum nitride, boron nitride, silver, gold, copper, platinum, nickel, diamond, magnesium oxide, zinc oxide, zirconium oxide, silicon carbide, titanium dioxide, other high performance thermal transfer materials, and combinations thereof. The particles may have a size of less than about 500 microns. When present, the filler is typically present in a range between about 10 weight % and about 95 weight %, based on the weight of the thermal transfer material. More typically, the filler is present in a range between about 20 weight % and about 90 weight %.

The lamp assembly may be mounted to a support surface, such as a ceiling (not shown), for example, through the chassis or ballast box. In the exemplary embodiment, the lamp is situated in an environment where temperatures can be relatively high, such as above 50° C. or above 60° C., or more, during operation of the lamp, such as in a high-ceilinged facility or in a factory where considerable heat is generated. As a result, the air surrounding the ballast does not conduct heat away from the ballast 22 to the same extent that it would do in normal environments. The RTV silicone, or other thermal transfer material, allows heat to be conducted away from the ballast to the lamp fixture.

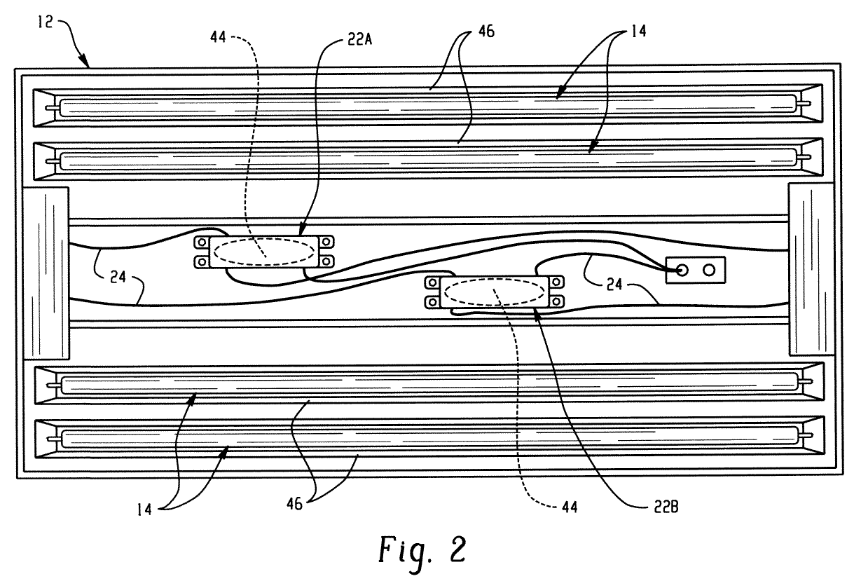

With reference to FIG. 2 another embodiment of a lamp fixture is shown, where similar elements are accorded the same numerals. In this embodiment, two ballasts 22A,B are mounted to a chassis 12 of a lamp fixture, for example, with bolts, screws, or other fixing members. A thermal transfer material 44 (illustrated in phantom) is disposed between the ballast and the chassis. In this embodiment, the ballast is positioned on the same side of the chassis as fluorescent lamps 14. The lamps are housed in reflector housings 46 which reflect light away from the chassis. Four lamps are illustrated, although it is to be appreciated that fewer or more than two lamps may be employed. Each ballast in the illustrated embodiment serves two lamps.

The invention has been described with reference to the preferred embodiments. Obviously, modifications and alterations will occur to others upon reading and understanding the preceding detailed description. It is intended that the invention be construed as including all such modifications and alterations.

1. A fluorescent lamp assembly comprising:
a fixture which supports at least one fluorescent lamp;
a ballast mounted to the fixture for controlling a supply of electrical current to the fluorescent lamp; and
a thermal transfer material interposed between the ballast and a portion of the fixture whereby heat is transferred between the ballast and the fixture, the thermal transfer material comprising an adhesive.

2. (canceled)

3. The fluorescent lamp assembly of claim 1, wherein the thermal transfer material comprises a polymeric matrix.

4. The fluorescent lamp assembly of claim 3, wherein the polymeric matrix comprises a silicone.

5. The fluorescent lamp assembly of claim 4, wherein the silicone comprises a room temperature vulcanizing silicone.

6. The fluorescent lamp assembly of claim 3, further comprising a particulate material dispersed in the polymeric matrix.

7. The fluorescent lamp assembly of claim 1, wherein the thermal transfer material remains in thermal contact with the ballast and the fixture at a temperature in excess of about 50° C.

8. The fluorescent lamp assembly of claim 1 wherein the ballast is mounted to the fixture by fixing members.

9. The fluorescent lamp assembly of claim 1, wherein the fixture includes a chassis which carries the at least one fluorescent lamp on a first side and wherein the ballast is mounted to the chassis at a second side.

10. The fluorescent lamp of claim 9, wherein the ballast is mounted by a ballast housing to the chassis and wherein the thermal transfer material is interposed between the ballast housing and the ballast.

11. The fluorescent lamp of claim 10, wherein the ballast includes a housing which houses electronic components of the ballast and wherein the thermal contact material is in direct contact with the ballast housing.

12. A method of operating a fluorescent lamp assembly in an environment which reaches temperatures in excess of about 50° C. during operation of the lamp, comprising:
supporting at least one fluorescent lamp on a fixture;
mounting a ballast to the fixture; and
interposing an adhesive thermal transfer material between the ballast and a portion of the fixture whereby heat is transferred between the ballast and the fixture during operation of the lamp.

13. (canceled)

14. The method of claim 12, wherein the thermal transfer material comprises a polymeric matrix.

15. The method of claim 14, wherein the polymeric matrix comprises a silicone.

16. The method of claim 12, wherein the thermal transfer material remains in thermal contact with the ballast and the fixture at a temperature in excess of about 50° C.

17. The method of claim 12, wherein the ballast is mounted to the fixture by fixing members.

18. The method of claim 12, wherein the ballast includes a housing which houses electronic components of the ballast and wherein the thermal contact material is in direct contact with the ballast housing.

19. A fluorescent lamp assembly comprising a ballast and a fixture which supports a fluorescent lamp, the ballast being adhesively attached to the fixture with a thermal transfer material comprising a room temperature vulcanizing silicone, the thermal transfer material conducting heat from the ballast to the fixture during operation of the fluorescent lamp at an ambient temperature of at least 50° C.

20. The fluorescent lamp assembly of claim 19, wherein the lamp assembly includes a chassis which supports the fluorescent lamp and a ballast box which mounts the ballast to the chassis so as to provide an air gap between the ballast and the chassis, the thermal transfer material being interposed between the ballast box and the ballast.

21. The fluorescent lamp assembly of claim 19, wherein the thermal transfer material further comprises a particulate material.
